(19) United States
(12) Patent Application Publication
(10) Pub. No.: US 2023/0009748 A1
(43) Pub. Date: Jan. 12, 2023

(54) CONTROL DEVICE, OPERATION MANAGEMENT SYSTEM, AND OPERATION MANAGEMENT METHOD

(71) Applicant: TOYOTA JIDOSHA KABUSHIKI KAISHA, Toyota-shi (JP)

(72) Inventors: Keiichiro FUJITA, Nisshin-shi (JP); Yukari SUZUKI, Fukuoka-shi (JP); Kazuya IWATA, Nagoya-shi (JP); Yota SAKURAI, Tokyo (JP)

(73) Assignee: TOYOTA JIDOSHA KABUSHIKI KAISHA, Toyota-shi (JP)

(21) Appl. No.: 17/729,075

(22) Filed: Apr. 26, 2022

(30) Foreign Application Priority Data
Jul. 9, 2021 (JP) 2021-114587

(51) Int. Cl. G06Q 10/08; G07C 5/00; G01C 21/36

(52) U.S. Cl. CPC G06Q 10/0833; G07C 5/008; G01C 21/3605

(57) ABSTRACT

A server device includes a communication unit and a control unit that communicates via the communication unit. The control unit receives, from a plurality of terminal devices, requests to receive a service from one vehicle, each of the requests specifying a provision period and a provision section of the service. Of a plurality of such moving processes that the vehicle is located in the provision section during the provision period of each of one or more services, the control unit sends, to the vehicle, information instructing the vehicle to perform a moving process with a higher total score assigned to a service included in the moving process than a remainder of the moving processes.

### CROSS-REFERENCE TO RELATED APPLICATION

This application claims priority to Japanese Patent Application No. 2021-114587 filed on Jul. 9, 2021, incorporated herein by reference in its entirety.

### BACKGROUND

### 1. Technical Field

The present disclosure relates to control devices, operation management systems, and operation management methods.

### 2. Description of Related Art

Methods have been proposed in which taxis are used not only to transport passengers but also to deliver goods. For example, Japanese Unexamined Patent Application Publication No. 2001-351170 (JP 2001-351170 A) discloses a delivery service system for requesting a taxi to deliver goods.

### SUMMARY

There is room to improve the efficiency of vehicle operation management when using vehicles for transporting passengers to deliver goods etc.

The present disclosure provides a server device etc. that make it possible to perform efficient operation management of a vehicle that provides a passenger transport service and other service.

A server device in the present disclosure includes a communication unit and a control unit that communicates via the communication unit. The control unit receives, from a plurality of terminal devices, requests to receive a service from one vehicle, each of the requests specifying a provision period and a provision section of the service. Of a plurality of such moving processes that the vehicle is located in the provision section during the provision period of each of one or more services, the control unit sends, to the vehicle, information instructing the vehicle to perform a moving process with a higher total score assigned to a service included in the moving process than a remainder of the moving processes.

An operation management system in the present disclosure includes one vehicle and a server device that communicates with the vehicle. The server device receives, from a plurality of terminal devices, requests to receive a service from the vehicle, each of the requests specifying a provision period and a provision section of the service. Of a plurality of such moving processes that the vehicle is located in the provision section during the provision period of each of one or more services, the server device sends, to the vehicle, information instructing the vehicle to perform a moving process with a higher total score assigned to a service included in the moving process than a remainder of the moving processes. The vehicle operates according to the moving process sent from the server device.

In an operation management method for a vehicle by a server device that communicates with one vehicle in the present disclosure, the server device receives, from a plurality of terminal devices, requests to receive a service from the vehicle, each of the requests specifying a provision period and a provision section of the service. Of a plurality of such moving processes that the vehicle is located in the provision section during the provision period of each of one or more services, the server device sends, to the vehicle, information instructing the vehicle to perform a moving process with a higher total score assigned to a service included in the moving process than a remainder of the moving processes. The vehicle operates according to the moving process sent from the server device.

The server device etc. of the present disclosure makes it possible to perform efficient operation management of a vehicle that provides a passenger transport service and other service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a configuration example of an operation management system;

FIG. 2 shows a configuration example of a server device;

FIG. 3 shows a configuration example of a vehicle;

FIG. 4 shows a configuration example of a terminal device;

FIG. 5 is a sequence diagram showing an operation example of the operation management system;

FIG. 6 is a flowchart showing an operation example of the server device;

FIG. 7A shows an example of a moving process;

FIG. 7B shows an example of the moving process; and

FIG. 7C shows an example of the moving process.

### DETAILED DESCRIPTION OF EMBODIMENTS

Hereinafter, an embodiment will be described.

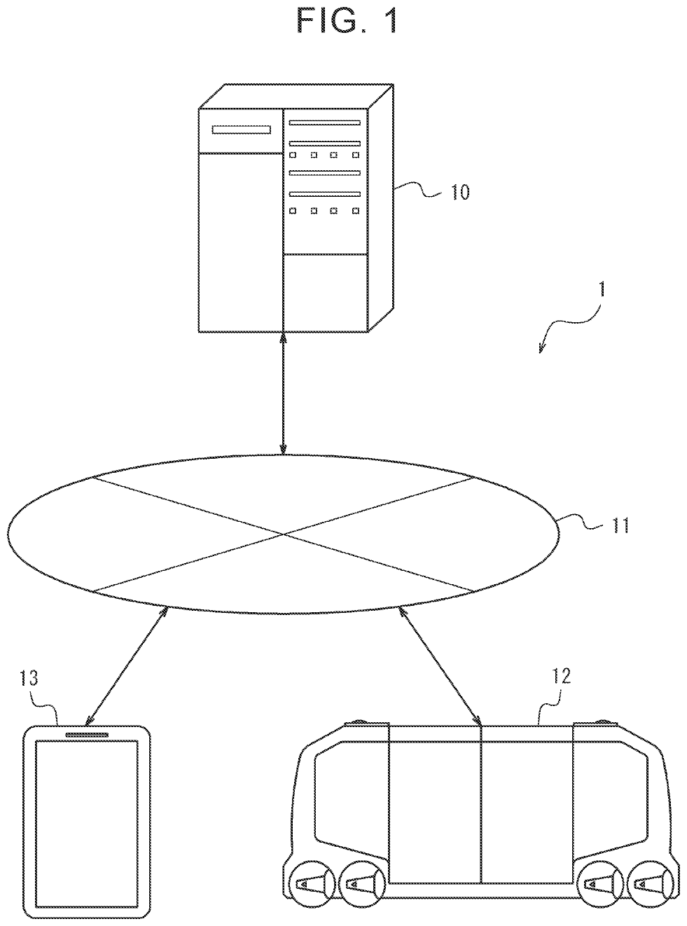

FIG. 1 shows a configuration example of an operation management system according to one embodiment. An operation management system 1 includes one or more server devices 10, one or more vehicles 12, and one or more terminal devices 13. The one or more server devices 10, the one or more vehicles 12, and the one or more terminal devices 13 are connected to each other via a network 11 so that they can communicate with each other. The server device 10 is, for example, a server computer belonging to a cloud computing system or other computing system and functioning as a server implemented with various functions. The vehicle 12 has a communication function and an information processing function, and is connected to the network 11 via a mobile communication network. The vehicle 12 is, for example, a circulator bus that serves a specific area. The vehicle 12 may be driven by a driver, or may be automated at a desired level (e.g., one of Levels 1 to 5 defined by the Society of Automotive Engineers (SAE)). The vehicle 12 is a battery electric vehicle or hybrid electric vehicle that uses battery power for at least part of the energy for traveling. The terminal device 13 is, for example, an information terminal device having a communication function such as a smartphone or a tablet terminal device, and is used by a user who receives a service provided by the vehicle 12. For example, the network 11 is the Internet. Other examples of the network 11 include an ad hoc network, a local area network (LAN), a metropolitan area network (MAN), other network, and any combination thereof.

In the present embodiment, the operation management system 1 manages the operation of the vehicle 12 by optimizing a moving process of the vehicle 12 by the server device 10 when the user of the terminal device 13 receives various services provided by the vehicle 12. The server device 10 includes a communication unit and a control unit that communicates via the communication unit. The control unit of the server device 10 receives requests to receive a service from one vehicle 12 from a plurality of the terminal devices 13, each request specifying a provision period and a provision section of the service. Of a plurality of such moving processes that the vehicle 12 is located in the provision section during the provision period of each of the one or more services, the control unit sends, to the vehicle 12, information instructing the vehicle 12 to perform the moving process with a higher total score assigned to the one or more services included in the moving process than the remainder of the moving processes. The services provided by the vehicle 12 include a transport service for transporting a user as a passenger. The provision period and provision section of the transport service are the period from the departure time to the arrival time specified by the user and the section from the point of departure to the destination specified by the user. The services provided by the vehicle 12 further include a delivery service for delivering goods at the request of a user who wishes to send or receive the goods. The provision period and provision section of the delivery service are the period from the time of shipping to the time of delivery of the goods desired by the user and the section from the point of shipping to the point of delivery of the goods desired by the user. The services provided by the vehicle 12 further include a power supply service for supplying electric power of the vehicle 12 to a device the user wishes to supply electric power to. The provision period and provision section of the power supply service are the period from the start time to the end time of the power supply and the power supply point where the power supply is performed. The provision section herein includes the case where the start point and the end point match. That is, the provision section includes the power supply point.

The vehicle 12 moves at or below the speed limit according to the road included in a travel route. When the vehicle 12 provides various services, the time required for the vehicle 12 to provide each service includes a travel time from the current position to the start point of the provision section of the service and the provision time of the service. Accordingly, there may be a case where the time required for the vehicle 12 to provide a service conflicts between or among the services and not all of the services requested from the terminal devices 13 can be provided by one vehicle 12. In such a case, of a plurality of such moving processes that the vehicle 12 is located in the provision section during the provision period of each service, the server device 10 causes the vehicle 12 to perform the moving process with a higher total score assigned to the services included in the moving process. The score corresponds to, for example, the consideration for each service an operating company of the vehicle 12 receives by providing the service to the user. The operating company of the vehicle 12 can thus manage the operation of the vehicle 12 so as to maximize profit from providing the services while providing the services to more users of the terminal devices 13. Accordingly, the operating company of the vehicle 12 can more efficiently manage the operation of the vehicle 12.

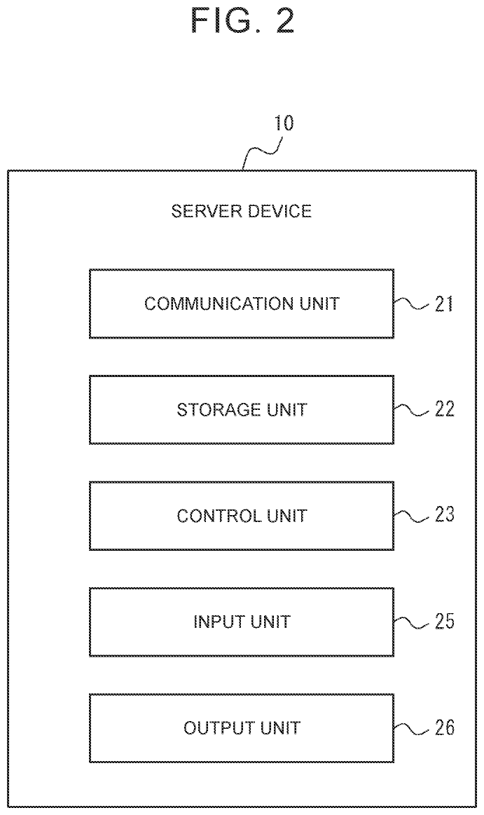

FIG. 2 illustrates a configuration example of the server device 10. The server device 10 includes a communication unit 21, a storage unit 22, a control unit 23, an input unit 25, and an output unit 26. The server device 10 is, for example, one computer. Alternatively, the server device 10 may be composed of two or more computers that are connected so that the computers can communicate with each other and operate in cooperation with each other. In that case, the configuration shown in FIG. 2 is provided in each of the two or more computers as appropriate.

The communication unit 21 includes one or more communication interfaces. The communication interface is, for example, a LAN interface. The communication unit 21 receives information to be used for the operation of the server device 10, and sends information obtained through the operation of the server device 10. The server device 10 is connected to the network 11 through the communication unit 21 and communicates with the vehicle 12 via the network 11.

The storage unit 22 includes, for example, one or more semiconductor memories, one or more magnetic memories, one or more optical memories, or a combination of at least two of them that functions as a main storage device, an auxiliary storage device, or a cache memory. The semiconductor memory is, for example, a random access memory (RAM) or a read-only memory (ROM). The RAM is, for example, a static RAM (SRAM) or a dynamic RAM (DRAM). The ROM is, for example, an electrically erasable programmable ROM (EEPROM). The storage unit 22 stores information to be used for the operation of the server device 10 and information obtained through the operation of the server device 10.

The control unit 23 includes one or more processors, one or more dedicated circuits, or a combination thereof. The processor is a general-purpose processor such as a central processing unit (CPU) or a dedicated processor specialized for a specific process such as a graphics processing unit (GPU). The dedicated circuit is, for example, a field-programmable gate array (FPGA) or an application-specific integrated circuit (ASIC). The control unit 23 performs information processing related to the operation of the server device 10 while controlling each unit of the server device 10.

The input unit 25 includes one or more input interfaces. The input interface is, for example, a physical key, a capacitive key, a pointing device, a touch screen integrated with a display, or a microphone that receives voice input. The input unit 25 receives an operation for inputting information to be used for the operation of the server device 10, and sends the input information to the control unit 23.

The output unit 26 includes one or more output interfaces. The output interface is, for example, a display or a speaker. The display is, for example, a liquid crystal display (LCD) or an organic electroluminescence (EL) display. The output unit 26 outputs information obtained through the operation of the server device 10.

The functions of the server device 10 are implemented by executing a control program by the processor of the control unit 23. The control program is a program that causes a computer to perform the steps included in the operation of the server device 10 and thus causes the computer to implement the functions corresponding to the steps. That is, the control program is a program that causes the computer to function as the server device 10. Part or all of the functions of the server device 10 may be implemented by the dedicated circuit of the control unit 23. The control program may be stored in a non-transitory recording or storage medium that can be read by the server device 10, and the server device 10 may read the control program from the medium.

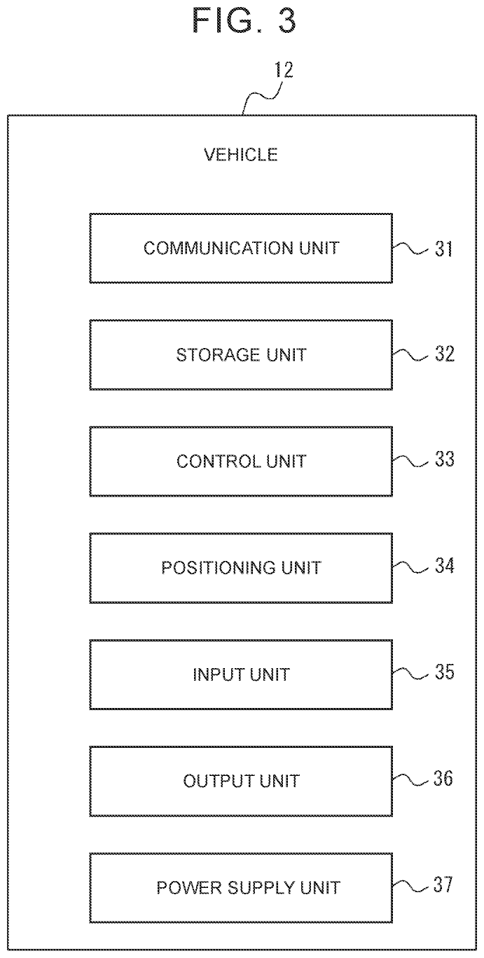

FIG. 3 shows a configuration example of the vehicle 12 according to the present embodiment. The vehicle 12 includes a communication unit 31, a storage unit 32, a control unit 33, a positioning unit 34, an input unit 35, an output unit 36, and a power supply unit 37. One or more of these units may be configured as one control device, or may be a personal computer including a tablet terminal, a smartphone terminal, and a navigation device. Alternatively, each unit may be connected so that it can communicate via an in-vehicle network conforming to a standard such as a controller area network (CAN).

The communication unit 31 includes one or more communication interfaces. The communication interface is, for example, an interface compatible with a mobile communication standard such as Long Term Evolution (LTE), 4th generation (4G), or 5th generation (5G). The communication unit 31 receives information to be used for the operation of the control unit 33, and sends information obtained through the operation of the control unit 33. The control unit 33 is connected to the network 11 through the communication unit 31 via a mobile communication base station, and communicates with other devices via the network 11.

The storage unit 32 includes one or more semiconductor memories, one or more magnetic memories, one or more optical memories, or a combination of at least two of them. The semiconductor memory is, for example, a RAM or a ROM. The RAM is, for example, an SRAM or a DRAM. The ROM is, for example, an EEPROM. The storage unit 32 functions as, for example, a main storage device, an auxiliary storage device, or a cache memory. The storage unit 32 stores information to be used for the operation of the control unit 33 and information obtained through the operation of the control unit 33.

The control unit 33 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 33 performs information processing related to the operation of the vehicle 12 while controlling each unit of the vehicle 12.

The positioning unit 34 includes one or more Global Navigation Satellite System (GNSS) receivers. The GNSS includes, for example, at least one of the following: Global Positioning System (GPS), Quasi-Zenith Satellite System (QZSS), BeiDou, Global Navigation Satellite System (GLONASS), and Galileo. The positioning unit 34 acquires position information of the vehicle 12.

The input unit 35 includes one or more input interfaces. The input interface is, for example, a physical key, a capacitive key, a pointing device, a touch screen integrated with a display, or a microphone that receives voice input. The input interface may further include a camera that captures an image or an image code, or an integrated circuit (IC) card reader. The input unit 35 receives an operation for inputting information to be used for the operation of the control unit 33, and sends the input information to the control unit 33.

The output unit 36 includes one or more output interfaces. The output interface is, for example, a display or a speaker. The display is, for example, an LCD or an organic EL display. The output unit 36 outputs information obtained through the operation of the control unit 33.

The power supply unit 37 includes an interface for charging and discharging a battery of the vehicle 12, and a control circuit for the interface. The interface includes a non-contact or contact interface for supplying electric power to various electronic devices or electric products outside the vehicle 12, other battery electric vehicles, etc. The power supply unit 37 supplies electric power to the outside as instructed by the control unit 33.

The functions of the control unit 33 are implemented by executing a control program by the processor of the control unit 33. The control program is a program that causes a computer to perform the steps included in the operation of the control unit 33 and thus causes the computer to implement the functions corresponding to the steps. That is, the control program is a program that causes the computer to function as the control unit 33. Part or all of the functions of the control unit 33 may be implemented by the dedicated circuit of the control unit 33.

The control unit 33 controls the communication unit 31, the storage unit 32, the positioning unit 34, the input unit 35, the output unit 36, and the power supply unit 37 while sending and receiving various kinds of information to and from these units, and controls the operation of the vehicle 12. When the vehicle 12 is operated, the control unit 33 controls the operation of the vehicle 12 by presenting various kinds of information necessary for driving to a driver via the output unit 36 and controlling autonomous driving of the vehicle 12.

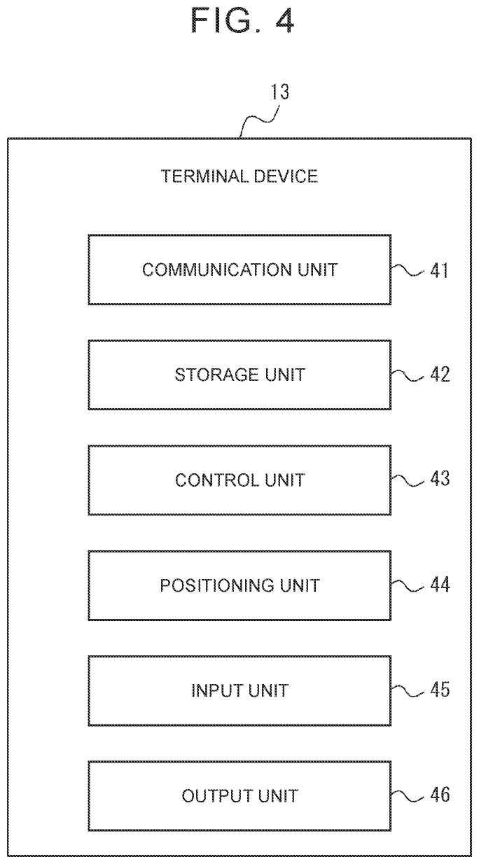

FIG. 4 illustrates a configuration of the terminal device 13. The terminal device 13 is an information terminal device such as a smartphone, a tablet terminal device, or a personal computer. The terminal device 13 includes a communication unit 41, a storage unit 42, a control unit 43, a positioning unit 44, an input unit 45, and an output unit 46.

The communication unit 41 includes a communication module compatible with a wired or wireless LAN standard, a module compatible with a mobile communication standard such as LTE, 4G, or 5G, etc. The terminal device 13 is connected to the network 11 through the communication unit 41 via a nearby router device or a mobile communication base station, and communicates with other devices via the network 11.

The storage unit 42 includes one or more semiconductor memories, one or more magnetic memories, one or more optical memories, or a combination of at least two of them. The semiconductor memory is, for example, a RAM or a ROM. The RAM is, for example, an SRAM or a DRAM. The ROM is, for example, an EEPROM. The storage unit 42 functions as, for example, a main storage device, an auxiliary storage device, or a cache memory. The storage unit 42 stores information to be used for the operation of the control unit 43 and information obtained through the operation of the control unit 43.

The control unit 43 includes, for example, one or more general-purpose processors such as a CPU and a micro processing unit (MPU), or one or more dedicated processors specialized for a specific process. Alternatively, the control unit 43 may include one or more dedicated circuits such as an FPGA and an ASIC. The control unit 43 comprehensively controls the operation of the terminal device 13 by operating according to a control and processing program or operating according to an operation procedure implemented as a circuit. The control unit 43 sends and receives various kinds of information to and from the server device 10 via the communication unit 41, and performs the operation according to the present embodiment.

The positioning unit 44 includes one or more GNSS receivers. The GNSS includes, for example, at least one of the following: GPS, QZSS, BeiDou, GLONASS, and Galileo. The positioning unit 44 acquires position information of the terminal device 13.

The input unit 45 includes one or more input interfaces. The input interface is, for example, a physical key, a capacitive key, a pointing device, a touch screen integrated with a display, or a microphone that receives voice input. The input interface may further include a camera that captures an image or an image code, or an IC card reader. The input unit 45 receives an operation for inputting information to be used for the operation of the control unit 43, and sends the input information to the control unit 43.

The output unit 46 includes one or more output interfaces. The output interface is, for example, a display or a speaker. The display is, for example, an LCD or an organic EL display. The output unit 46 outputs information obtained through the operation of the control unit 43.

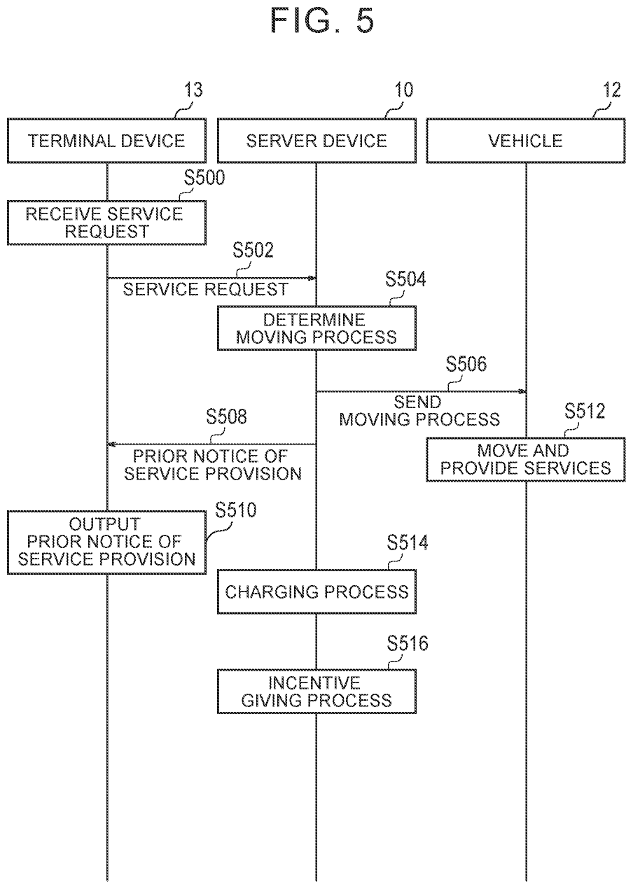

FIG. 5 is a sequence diagram illustrating an operation procedure of the operation management system 1. FIG. 5 shows a procedure related to linked operation among the server device 10, the vehicle 12, and the terminal device 13. The control unit 23 of the server device 10, the control unit 33 of the vehicle 12, and the control unit 43 of the terminal device 13 perform the steps related to various kinds of information processing of the server device 10, the vehicle 12, and the terminal device 13 in FIG. 5 by controlling each unit of the server device 10, the vehicle 12, and the terminal device 13. The control unit 23 of the server device 10, the control unit 33 of the vehicle 12, and the control unit 43 of the terminal device 13 perform the steps related to transmission and reception of various kinds of information of the server device 10, the vehicle 12, and the terminal device 13 by sending and receiving information via the communication unit 21, the communication unit 31, and the communication unit 41.

In step S500, the terminal device 13 receives a service request from the user. The service request includes not only the type of service desired by the user but also the provision period and provision section of the service. The control unit 43 receives an input from the user via the input unit 45. For example, the control unit 43 presents a menu of services provided by the vehicle 12 to the user by displaying it on the output unit 46, and receives information selected or entered by the user via the input unit 45. The user selects the menu on the display screen of the terminal device 13 and enters the type of service, the provision period, and the provision section. For example, the user enters or selects the time indicating the start time of the provision period and the time indicating the end time of the provision period. The user also selects a point indicating the start point of the provided section and a point indicating the end point of the provision section on a map. For example, when the user requests a transport service, the user enters the desired departure time and point of departure and the desired arrival time and destination. When the user requests a delivery service, the user enters the desired time and point of shipping and the desired time and point of delivery. When the user requests a power supply service, the user enters the desired start and end times of power supply and the desired point of power supply.

The control unit 43 may receive an input of information indicating that a change in provision period is allowed as well as information on the provision period. For example, the information indicating that a change in provision period is allowed is input when the user selects a service provision mode etc. on the display screen. For example, options such as “express” mode and “no rush” mode are displayed on the display screen. When the user selects the “express” mode, the control unit 23 receives information indicating that no change in provision period is allowed. When the user selects the “no rush” mode, the control unit 23 receives information indicating that a change in provision period is allowed.

In step S502, the terminal device 13 sends a service request to the server device 10. The service request includes user information identifying the user of the terminal device 13 and information on the type of service and the provision period and provision section of the service. The user information may be entered by the user in step S500, or may be stored in advance in the storage unit 32 of the terminal device 13. The server device 10 receives the service request. The information indicating that a change in provision period is allowed may be added to the information on the provision period.

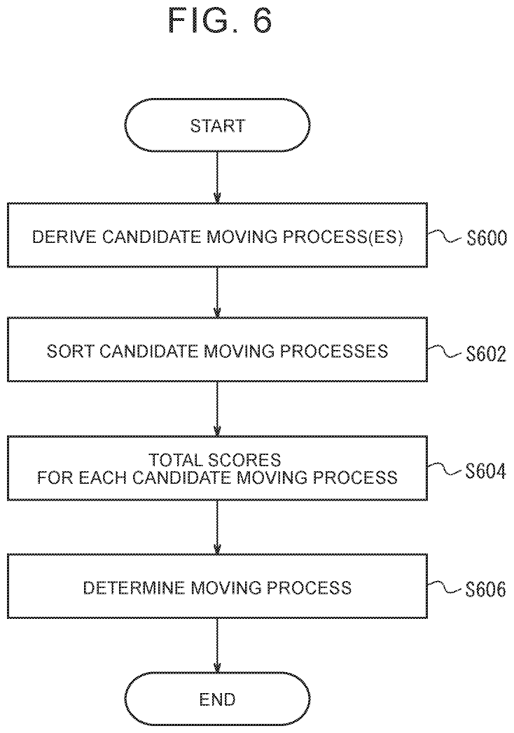

In step S504, the server device 10 determines a moving process of the vehicle 12 based on the service requests sent from the plurality of terminal devices 13. For example, the server device 10 determines a moving process based on requests received within a desired predetermined time (e.g., 30 minutes to one hour) before the operation start time of the vehicle 12 determined as desired and notified to the terminal device 13 in advance. FIG. 6 shows a detailed procedure of the operation of the control unit 43 in step S504.

In step S600 of FIG. 6, the control unit 23 derives one or more moving processes of the vehicle 12. The moving process(es) derived in this step is referred to as the “candidate moving process(es)” for convenience. The control unit 23 uses a desired algorithm to derive such a candidate moving process(es) that the vehicle 12 is located in the provision section during each provision period of one or more services.

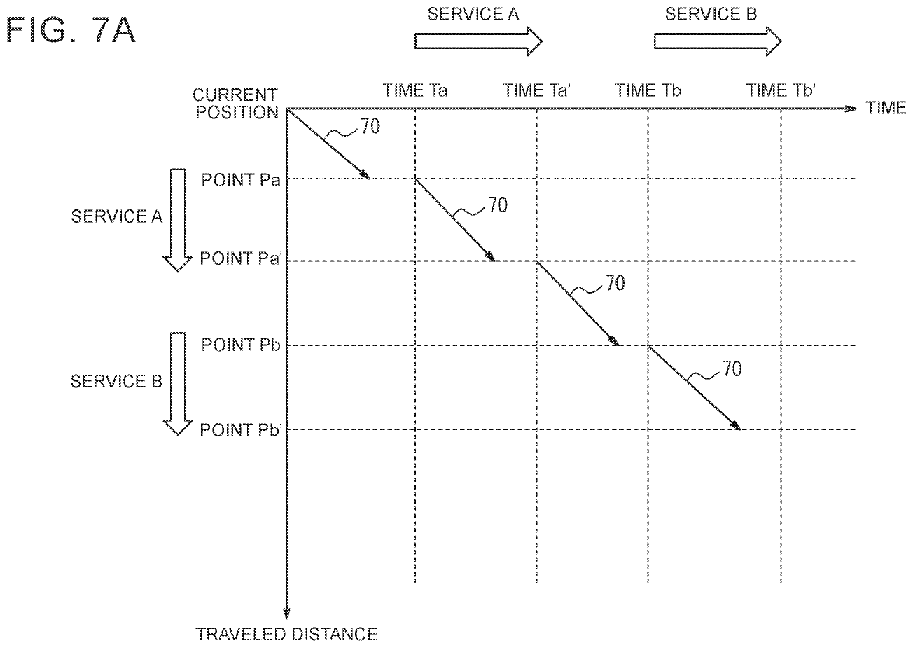

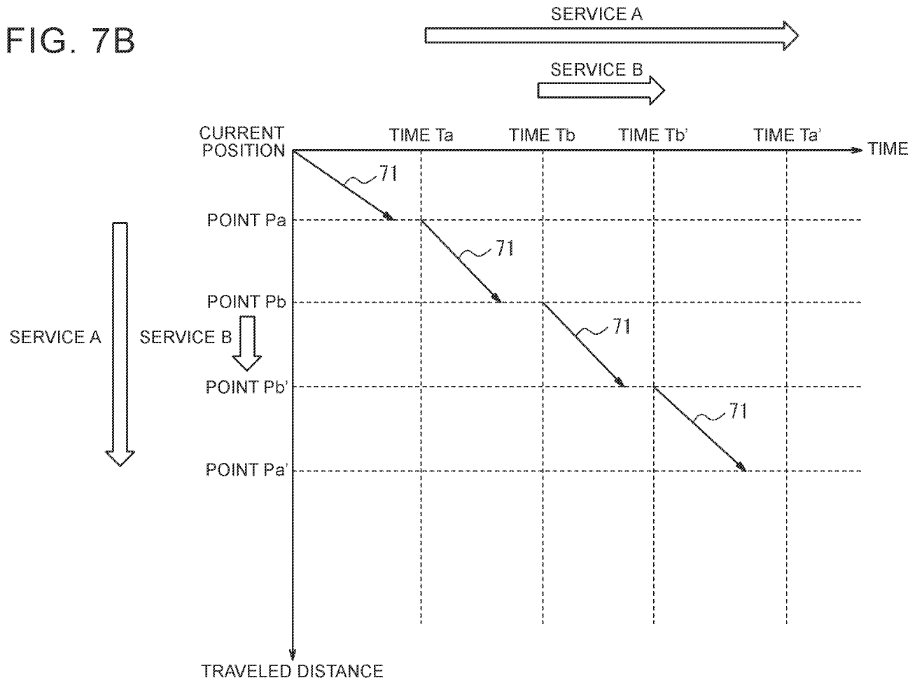

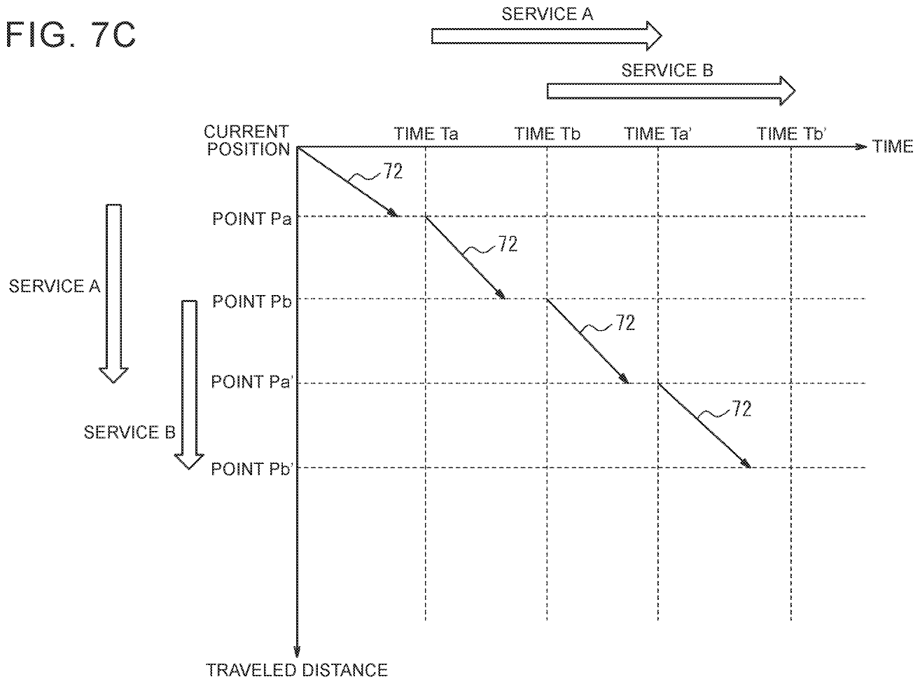

The moving process for providing two or more services will be described with reference to FIGS. 7A to 7C.

FIG. 7A shows an example of the moving process when the vehicle 12 provides two services. The ordinate represents the distance traveled from the current position of the vehicle 12, and the abscissa represents time. The provision period of a service A is indicated by time Ta to Ta′, the provision section of the service A is indicated by points Pa to Pa′, the provision period of a service B is indicated by time Tb to Tb′, and the provision section of the service B is indicated by points Pb to Pb′. The service A is, for example, a transport service in which the vehicle 12 leaves the point of departure Pa at the departure time Ta and arrives at the destination Pa′ by the arrival time Ta′. The service A may be a delivery service in which the vehicle 12 collects goods at the point of shipping Pa at the time of shipping Ta and leaves the point of shipping Pa, and arrives at the point of delivery Pa′ by the time of delivery Ta′ and delivers the goods. Alternatively, the service A may be a power supply service. In that case, the point Pa and the point Pa′ are the same, namely the traveled distance is zero, and the vehicle 12 stands by for power supply or supplies electric power from the power supply start time Ta to the power supply end time Ta′ at the power supply point Pa. Similarly, the service B is, for example, a transport service in which the vehicle 12 leaves the point of departure Pb at the departure time Tb and arrives at the destination Pb′ by the arrival time Tb′. The service B may be a delivery service in which the vehicle 12 collects goods at the point of shipping Pb at the time of shipping Tb and leaves the point of shipping Pb, and arrives at the point of delivery Pb′ by the time of delivery Tb′ and delivers the goods. Alternatively, the service B may be a power supply service in which the vehicle 12 stands by for power supply or supplies electric power from the power supply start time Tb to the power supply end time Tb′ at the power supply point Pb, that is, the point Pb′. FIG. 7A shows a moving process 70 in which, after providing the service A, the vehicle 12 moves from the end point Pa′ of the provision section of the service A to the start point Pb of the provision section of the service B and provides the service B.

FIG. 7B shows a moving process 71 in which, when providing the two services A, B, the vehicle 12 moves to the start point Pb of the provision section of the service B and provides the service B while providing the service A, and completes provision of the service A after providing the service B. The example of FIG. 7B is, for example, the case where the service A is a transport service or a delivery service and the service B is a transport service, a delivery service, or a power supply service. For example, the vehicle 12 transports the user, delivers goods, or supplies electric power for the service B while transporting the user or delivering goods for the service A. Thereafter, the vehicle 12 completes the transport or delivery for the service A.

FIG. 7C shows a moving process 72 in which, when providing the two services A, B, the vehicle 12 moves to the start point Pb of the provision section of the service B and starts the service B while providing the service A, and completes provision of the service B after providing the service A. The example of FIG. 7C is, for example, the case where the services A, B are both a transport service or a delivery service. For example, the vehicle 12 picks up the user for transport or collects goods for delivery for the service B while transporting the user or delivering goods for the service A. Thereafter, the vehicle 12 completes the transport or delivery for the service A and then completes the transport or delivery for the service B.

FIGS. 7B and 7C show examples in which, when providing two services, the vehicle 12 provides or starts providing the other service while providing one service. However, the present embodiment is also applied to the case where the vehicle 12 provides or starts providing two or more other services while providing one service.

When the vehicle 12 provides two or more services, the control unit 23 combines such moving processes as shown in FIGS. 7A to 7C as appropriate in consideration of the provision section and provision period of each service to derive a candidate moving process for providing more services. At that time, there may be a case where the required time including both the travel time to the start point of the provision section of the service and the provision period of the service conflicts between or among the services of the vehicle 12 and not all of the requested services can be provided by one vehicle 12. In such a case, the control unit 23 derives a plurality of candidate moving processes including as many services as the vehicle 12 can provide. When any of service requests received from the terminal device 13 includes information indicating that a change in provision period is allowed, the control unit 23 may move up or put off the provision period of that service as appropriate to derive a candidate moving process including more services. When the provision period is changed, the control unit 23 stores the user information of the terminal device 13 that requested that service in the storage unit 22 in association with information indicating that the provision period has been changed.

In step S602 of FIG. 6, the control unit 23 sorts the derived candidate moving processes. The control unit 23 checks for each candidate moving process whether the return time the vehicle 12 is expected to return to the base after completing provision of all the services is preset reference time or before the present reference time. For example, the reference time is set as desired between 21:00 and 24:00 according to the end of their business day. The control unit 23 rules out any candidate moving process, of which return time is after the reference time.

In step S604, the control unit 23 totals the scores for each selected candidate moving process. The control unit 23 assigns a score to each service included in each candidate moving process. The score corresponds to, for example, the consideration for each service the operating company of the vehicle 12 receives by providing the service to the user. For example, a score of “170” is assigned to the transport service, a score of “100” is assigned to the delivery service, and a score of “50” is assigned to the power supply service. The control unit 23 then totals the scores for each candidate moving process. The control unit 23 may further calculate the total required time for each candidate moving process by adding up the travel time and the provision times of the services, and divide the total score by the total required time to calculate the score per unit required time. The control unit 23 may weight the scores. For example, the control unit 23 may assign more weight to the score of the service, for which a provision period will not be changed, than to the score of the service for which a change in provision period is allowed, and total the scores with the weights. In this case, the candidate moving process including more urgent services has a higher total score, making it possible to more reliably provide the urgent services.

In step S606, the control unit 23 determines the candidate moving process with the highest total score or the highest score per unit required time to be the moving process to be sent to the vehicle 12.

In step S506 of FIG. 5, the server device 10 sends the moving process to the vehicle 12. The vehicle 12 receives an instruction about the moving process from the server device 10.

In step S508, the server device 10 sends prior notice of service provision to each terminal device 13 that requested the service included in the moving process. The prior notice includes information on the start point of the provision section and the start time of the provision period at which provision the service is started. Each terminal device 13 receives the prior notice.

In step S510, each terminal device 13 outputs the prior notice of service provision. For example, the control unit 43 displays the prior notice on the output unit 46 to notify the user that the user can receive the desired service. In response to this, the user moves to, for example, the start point of the provision section of the service by the start time of the provision period and prepares to receive the service.

In step S512, the vehicle 12 moves according to the moving process sent from the server device 10 and sequentially provides the services. For example, the vehicle 12 picks up the user at the point of departure, collects goods at the point of shipping, or starts power supply at the power supply point by the start time of the provision period of the service. The vehicle 12 then moves to the destination to complete the transport of the user, moves to the point of delivery to complete the delivery of the goods, or completes the power supply at the power supply point by the end time of the provision period of the service.

In step S514, the server device 10 performs a charging process. The control unit 23 performs a process of charging the user who requested the service included in the moving process sent to the vehicle 12 for the service. For example, the control unit 23 performs the charging process according to the consideration for the service by using account information of a financial institution linked to user information of the user.

In step S516, the server device 10 performs a process of giving an incentive. When the moving process determined to be sent to the vehicle 12 has been derived by changing the provision period of any service, the control unit 23 performs a process of giving an incentive to the user who has allowed a change in provision period. For example, the control unit 23 performs a process of giving points, coupons, etc. in association with the user information of that user. Giving such an incentive encourages the users to make a flexible service request and increases the flexibility in deriving the candidate moving processes. Giving such an incentive also motivates the users to use the services.

According to the above procedure, the operating company of the vehicle 12 can manage the operation of the vehicle 12 so as to maximize profit from providing the services while allowing the vehicle 12 to provide the services to more users of the terminal devices 13. Accordingly, the operating company of the vehicle 12 can more efficiently manage the operation of the vehicle 12.

In the above description, the vehicle 12 is a circulator bus. However, the present embodiment is also applied even when the vehicle 12 is one of various vehicles such as a passenger car etc. provided for a car sharing service. Even after the vehicle 12 starts moving, the server device 10 may receive a request from the terminal device 13 as necessary, and may add or update a travel route as necessary.

Although the embodiment is described above based on the drawings and examples, it should be noted that those skilled in the art can readily make various modifications and alterations thereto based on the present disclosure. It is therefore to be understood that these modifications and alterations are within the scope of the present disclosure. For example, the functions etc. included in each means, each step, etc. can be rearranged so as not to be logically inconsistent, and a plurality of means, steps, etc. may be combined into single means, step, etc. or each means, each step, etc. may be divided into a plurality of means, a plurality of steps, etc.

What is claimed is:

1. A server device, comprising:
a communication unit; and
a control unit that communicates via the communication unit, wherein the control unit receives, from a plurality of terminal devices, requests to receive a service from one vehicle, each of the requests specifying a provision period and a provision section of the service, and of a plurality of such moving processes that the vehicle is located in the provision section during the provision period of each of one or more services, the control unit sends, to the vehicle, information instructing the vehicle to perform a moving process with a higher total score assigned to a service included in the moving process than a remainder of the moving processes.

2. The server device according to claim 1, wherein when the request includes information indicating that a change in the provision period is allowed, the control unit changes the provision period and determines the moving process to be performed by the vehicle.

3. The server device according to claim 2, wherein the control unit performs a process of giving an incentive to a user of the terminal device who sent the request including the information indicating that a change in the provision period is allowed.

4. The server device according to claim 2, wherein the control unit determines the moving process to be performed by the vehicle on condition that provision of the service included in the moving process is completed by reference time.

5. The server device according to claim 1, wherein the service includes a transport service for transporting a user, and the provision period and the provision section of the transport service are a period from departure time to arrival time and a section from a point of departure to a destination.

6. The server device according to claim 1, wherein the service includes a delivery service for delivering goods, and the provision period and the provision section for the delivery service are a period from time of shipping to time of delivery and a section from a point of shipping to a point of delivery.

7. The server device according to claim 1, wherein the service includes a power supply service for supplying electric power of the vehicle to another device, and the provision period and the provision section for the power supply service are a period from start time to end time of the power supply and a point where the power supply is performed.

8. An operation management system, comprising:
one vehicle; and
a server device that communicates with the vehicle, wherein:
the server device receives, from a plurality of terminal devices, requests to receive a service from the vehicle, each of the requests specifying a provision period and a provision section of the service, and of a plurality of such moving processes that the vehicle is located in the provision section during the provision period of each of one or more services, the server device sends, to the vehicle, information instructing the vehicle to perform a moving process with a higher total score assigned to a service included in the moving process than a remainder of the moving processes; and
the vehicle operates according to the moving process sent from the server device.

9. The operation management system according to claim 8, wherein when the request includes information indicating that a change in the provision period is allowed, the server device changes the provision period and determines the moving process to be performed by the vehicle.

10. The operation management system according to claim 9, wherein the server device performs a process of giving an incentive to a user of the terminal device who sent the request including the information indicating that a change in the provision period is allowed.

11. The operation management system according to claim 9, wherein the server device determines the moving process to be performed by the vehicle on condition that provision of the service included in the moving process is completed by reference time.

12. The operation management system according to claim 8, wherein the service includes a transport service for transporting a user, and the provision period and the provision section of the transport service are a period from departure time to arrival time and a section from a point of departure to a destination.

13. The operation management system according to claim 8, wherein the service includes a delivery service for delivering goods, and the provision period and the provision section for the delivery service are a period from time of shipping to time of delivery and a section from a point of shipping to a point of delivery.

14. The operation management system according to claim 8, wherein the service includes a power supply service for supplying electric power of the vehicle to another device, and the provision period and the provision section for the power supply service are a period from start time to end time of the power supply and a point where the power supply is performed.

15. An operation management method for a vehicle by a server device that communicates with one vehicle, wherein:
the server device receives, from a plurality of terminal devices, requests to receive a service from the vehicle, each of the requests specifying a provision period and a provision section of the service, and of a plurality of such moving processes that the vehicle is located in the provision section during the provision period of each of one or more services, the server device sends, to the vehicle, information instructing the vehicle to perform a moving process with a higher total score assigned to a service included in the moving process than a remainder of the moving processes; and
the vehicle operates according to the moving process sent from the server device.

16. The operation management method according to claim 15, wherein when the request includes information indicating that a change in the provision period is allowed, the server device changes the provision period and determines the moving process to be performed by the vehicle.

17. The operation management method according to claim 16, wherein the server device performs a process of giving an incentive to a user of the terminal device who sent the request including the information indicating that a change in the provision period is allowed.

18. The operation management method according to claim 16, wherein the server device determines the moving process to be performed by the vehicle on condition that provision of the service included in the moving process is completed by reference time.

19. The operation management method according to claim 15, wherein the service includes a transport service for transporting a user, and the provision period and the provision section of the transport service are a period from departure time to arrival time and a section from a point of departure to a destination.

20. The operation management method according to claim 15, wherein the service includes a delivery service for delivering goods, and the provision period and the provision section for the delivery service are a period from time of shipping to time of delivery and a section from a point of shipping to a point of delivery.
